(19) United States
(12) Patent Application Publication
(10) Pub. No.: US 2010/0325681 A1
(43) Pub. Date: Dec. 23, 2010

(54) RECEIVER, RECEIVING METHOD, AND DATA COMMUNICATION SYSTEM

(76) Inventors: Hiroyuki Chaki, Akiruno-shi (JP); Takashige Kimura, Nishitama-gun (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/759,507

(22) Filed: Apr. 13, 2010

(30) Foreign Application Priority Data
Jun. 22, 2009 (JP) 2009-147571

(51) Int. Cl. H04N 7/173

(52) U.S. Cl. 725/133

(57) ABSTRACT

According to an aspect of the present invention, there is provided a receiver configured to perform browsing of information relating to a broadcast program to be received and/or recorded by accessing to an Internet server being independent of the broadcast program, the receiver including: a browsing module configured to perform the browsing; a recording module configured to start, upon a start of the browsing, recording of the broadcast program being broadcasted and viewed; and a replying module configured to return, upon receiving of an acquisition request from the Internet server, identifying information relating to the broadcast program that has been viewed so far or being viewed to the server.

### CROSS-REFERENCE TO RELATED APPLICATIONS

This application is based upon and claims the benefit of priority from Japanese Patent Application No. 2009-147571, filed on Jun. 22, 2009, the entire contents of which are incorporated herein by reference.

### BACKGROUND

1. Field

An aspect of the present invention relates to a broadcast receiver, a receiving method, and a data communication system.

2. Description of the Related Art

In recent days, so called “time-shift playback” is widely used for viewing of a broadcast program. In connection with this trend, to present a suitable advertisement suitable for the broadcast program, there have been proposed receivers which enable information browsing by connecting to an Internet server that does not directly relate to broadcasting stations.

For example, in JP-2003-158726-A, information relating to an area, channel, and a broadcast start time is sent from the receiver to the server in the form of a URL. However, such information is communicated to only a server of the firstly-displayed page. Furthermore, even if a program can be identified on the server side, the degree of freedom is low and information cannot be provided so as to conform to the progress of a program.

The receiver disclosed in JP-2008-079139-A simultaneously performs display of a Web page and recording, and stars a playback when the Web browsing has finished. However, no consideration is given to how to deal with a recorded program. There is another problem (inconvenience) that a firstly-opened Web page will be restricted to the program-related page.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates an exemplary situation to which an embodiment is applied.

FIG. 2 illustrates the exemplary configuration of an apparatus 103 according to the embodiment.

FIG. 3 illustrates an example process which is executed by the apparatus 103 according to the embodiment.

FIGS. 4A and 4B illustrate an example script contained in a document that the apparatus 103 acquires from an apparatus 101 in the embodiment.

FIG. 5 illustrates an example process which is executed by the apparatus 101 according to the embodiment.

FIG. 6 illustrates an example operation of the embodiment.

### DETAILED DESCRIPTION

Various embodiments according to the present invention will be described hereinafter with reference to the accompanying drawings. In general, according to one embodiment of the present invention, there is provided a receiver configured to perform browsing of information relating to a broadcast program to be received and/or recorded by accessing to an Internet server being independent of the broadcast program, the receiver including: a browsing module configured to perform the browsing; a recording module configured to start, upon a start of the browsing, recording of the broadcast program being broadcasted and viewed; and a replying module configured to return, upon receiving of an acquisition request from the Internet server, identifying information relating to the broadcast program that has been viewed so far or being viewed to the server.

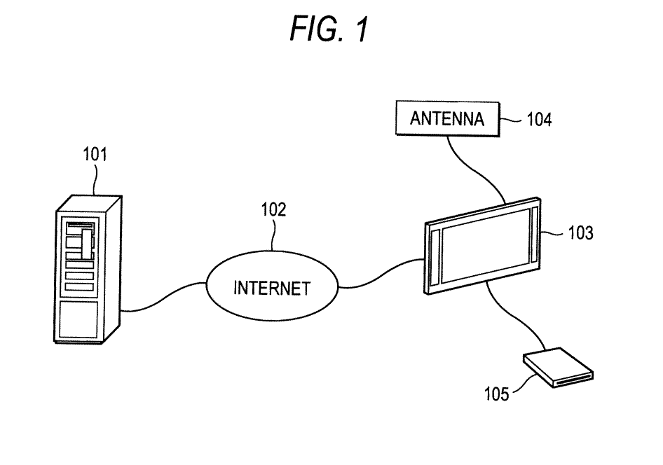

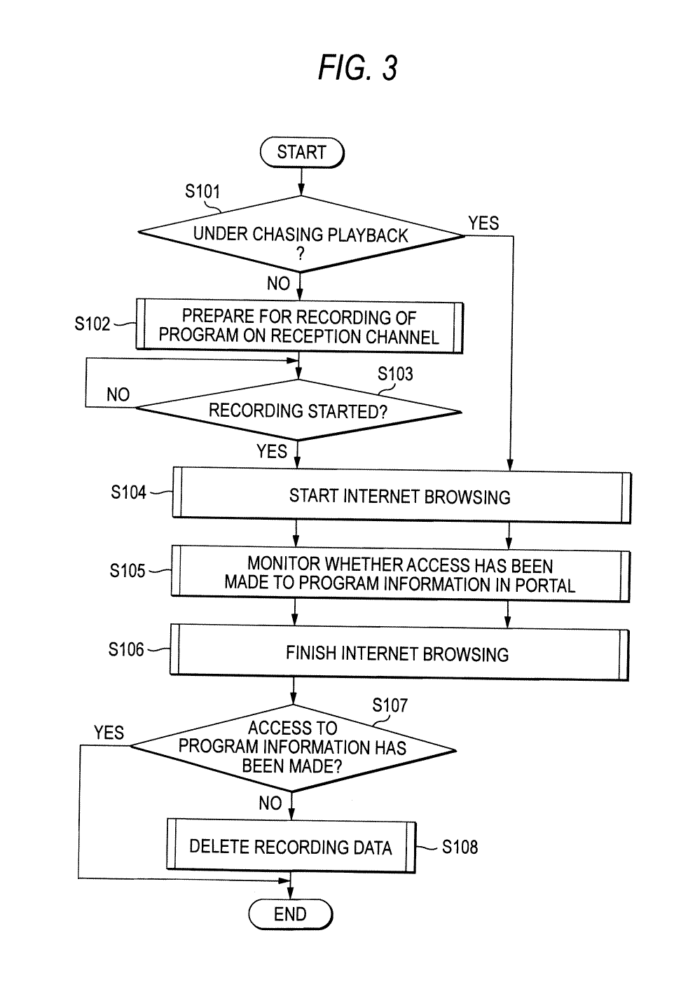

An embodiment of the present invention will be hereinafter described with reference to FIGS. 1-6.

FIG. 1 illustrates a situation to which the embodiment is applied. For example, as shown in FIG. 1, an apparatus 101 is connected to the Internet 102, and an apparatus 103 is also connected to the Internet and can communicate with the apparatus 101.

The apparatus 103 is manipulated by a user and can receive a content via an antenna 104. The apparatus 103 is equipped with a browser which acquires a document that is described in a markup language from the Internet 102 and presents it so as to be recognized visually by a human.

The apparatus 103 can store a content acquired via the antenna 104 into a device 105 such as an HDD (hard disk drive) or a recording apparatus and can take out a stored content.

In the embodiment, there will be described a browsing method of the apparatus 103 for allowing the user to browse without paying attention to the progress of a program and a method for enabling the apparatus 101 to automatically deliver information suitably corresponding to the progress of a program.

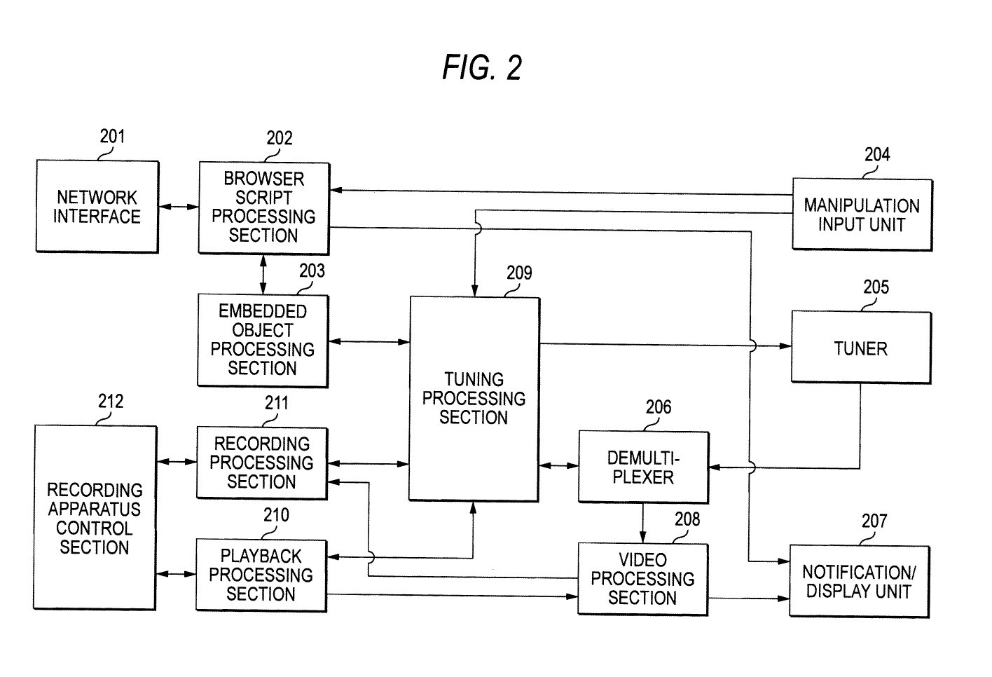

FIG. 2 illustrates the configuration of the apparatus 103 according to the embodiment. The apparatus 103 will be described below with reference to FIG. 2.

The apparatus 103 is equipped with a network interface 201, a tuner 205 for receiving a TV broadcast high-frequency signal having a particular bandwidth, and a demultiplexer 206 which returns a signal containing a multiplexed, high-transfer-rate stream that is supplied from the tuner 205 into plural low-transfer-rate streams, reconstructs video and audio PESs (packetized elementary streams) from an MPEG (Moving Picture Experts Group) 2 TS (transport stream) using packet identifiers PID that are contained in respective headers, and reconstructs sections of, for example, SI (service information) which is metainformation such as program information.

The apparatus 103 is also equipped with a tuning processing section 209 for tuning in to a program intended by a user by controlling the tuner 205 based on PSI (program specific information) and SI that are obtained by analyzing the sections that are supplied from the demultiplexer 206, a video processing section 208 for analyzing and decoding the PESs supplied from the demultiplexer 206, and a recording apparatus control section 212 for performing a recording/playback control on an apparatus such as an HDD that is built in the apparatus 103, connected thereto via a high-speed data-transfer interface such as a USE (universal serial bus), or operated independently so as to perform data writing and reading.

The apparatus 103 is also equipped with a recording processing section 211 which receives an instruction from the tuning processing section 209 together with the metainformation and records the metainformation and moving image data supplied form the video processing section 208 via the recording apparatus control section 212, a playback processing section 210 which receives an instruction from the tuning processing section 209 and takes out moving image data to be decoded by the video processing section 208 and metainformation to be returned to the turning processing section 209 via the recording apparatus control section 212, and a browser script processing section 202 which analyzes a document such as an HTML (hypertext markup language) and XML (extensible markup language) acquired from the apparatus 101 via the network interface 201 and presents it according to its description contents.

The apparatus 103 is further equipped with an embedded object processing section 203 which instructs the tuning processing section 209 to start recording, activates the browser script processing section 202, and, when requested to acquire viewing program identifying information in processing a script language such as Java®Script, acquires such information as an area, a channel, a program start time, and a playback position relating to a program that has been viewed so far or being viewed from the tuning processing section 209 and makes a reply and, at the same time, instructs the tuning processing section 209 to continue the recording until an end of the program; a manipulation input unit 204 for receiving the user's instructions for driving of the browser script processing section 202 and the tuning processing section 209; and a notification/display unit 207 for notifying the user of a processing result of the browser script processing section 202 and an output of the video processing section 208 that is produced under the control of the tuning processing section 209 by superimposing them on each other when necessary.

Next, a process to be executed by the apparatus 103 will be described with reference to a flowchart of Fig. The process is started in response to the user's instruction received through the manipulation input unit 204.

At step S101, the tuning processing section 209 judges, by inquiring of the recording processing section 211, whether a program on a reception channel is being recorded (i.e., chasing playback). If it is not being recorded, at step S102 the tuning processing section 209 instructs the recording processing section 211 to prepare for recording of the program on the reception channel.

At step S103, the tuning processing section 209 stands by until recording is started. Upon recognizing that recording has been started, at step S104 the tuning processing section 209 activates the browser script processing section 202 and causes it to present a document that is acquired from the apparatus 101. The browser script processing section 202 accepts a user's manipulation through the manipulation input unit 204.

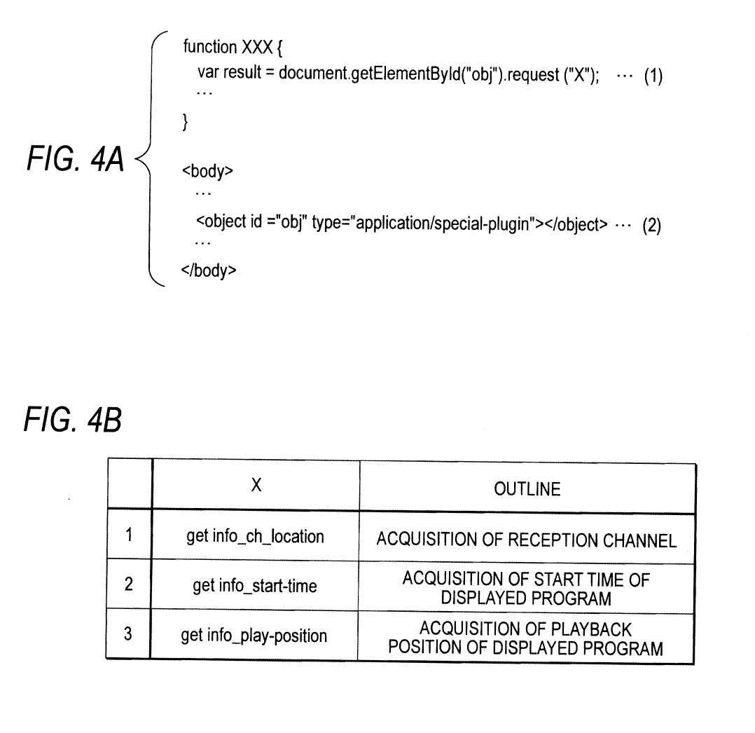

If the user orders a transition to a page that provides program information through a portal prepared by the apparatus 101, at step S105 the browser script processing section 202 acquires a document containing a dedicated script as shown in FIGS. 4A and 4B from the apparatus 101. FIG. 4A illustrates a request for acquiring viewing program identifying information. If a MIME (multipurpose Internet mail extension) type is predetermined as a “type” as shown in line (2) in FIG. 4A, the embedded object processing section 203 accepts a request from script processing as shown in line (1). For example, if the item corresponding to “X” on line (1) is “get info_ch_location” shown in FIG. 4B, the embedded object processing section 203 acquires information indicating a reception channel and makes a reply.

Viewing program identifying information includes, for example, a reception area, a channel, a start time of a program being displayed, and its playback position. The reception channel is determined so as to be discriminated in a reception area and a channel based on “transport_stream_id,” “original_network_id,” “service_id,” or the like which is obtained from EIT (event information table) indicating detailed information of the program as a part of SI. Likewise, the start time of the program being displayed can be acquired from “start_time” of the EIT. The playback position of the program being displayed can be acquired from TOT (time offset table) or TDT (time data table) which is SI corresponding to a reception time or DTS (decoding time stamp) in ESs (elementary streams) or a difference relationship between time-stamped TS packets obtained from the video processing section 208.

The viewing program identifying information obtained from the embedded object processing section 203 is used in an asynchronous communication using AJAX (asynchronous Java®Script+XML) or the like, in which a Java®Script embedding class for an HTTP (hypertext transfer protocol) is used, and part of the document is written dynamically according to a communication result. In this manner, the browser script processing section 202 presents information that conforms to the viewing program identifying information.

In the HTTP communication, GET method data communication and POST method data communication are possible. In view of privacy, since information relating to a program from which access is made to a URI (uniform resource identifier) is contained in transmission data and hence can be recognized by a third party by checking a history or the like, the GET method may not be used. A data communication may be performed by the POST method as it does not restrict the transmission data size.

In this manner, a communication is made with the apparatus 101 when necessary, whereby a document relating to a reception program is updated by a script that is written therein.

The embedded object processing section 203 may be configured to operate when it is confirmed that a document has been acquired via SSL (secure socket layer). This assures high security.

The embedded object processing section 203 stores information indicating whether a request for acquiring viewing program identifying information has been received.

At step S106, the operation of the browser script processing section 202 is finished in response to a user instruction. The tuning processing section 209 is informed of the end of operation of the browser script processing section 202 via the embedded object processing section 203.

If not having received a request for acquiring viewing program identifying information (S107: no), at step S108 the embedded object processing section 203 causes the tuning processing section 209 to instruct the recording processing section 211 to delete recorded data. However, the recording processing section 211 disregards such an instruction if it has already received a recording continuation instruction for the same program.

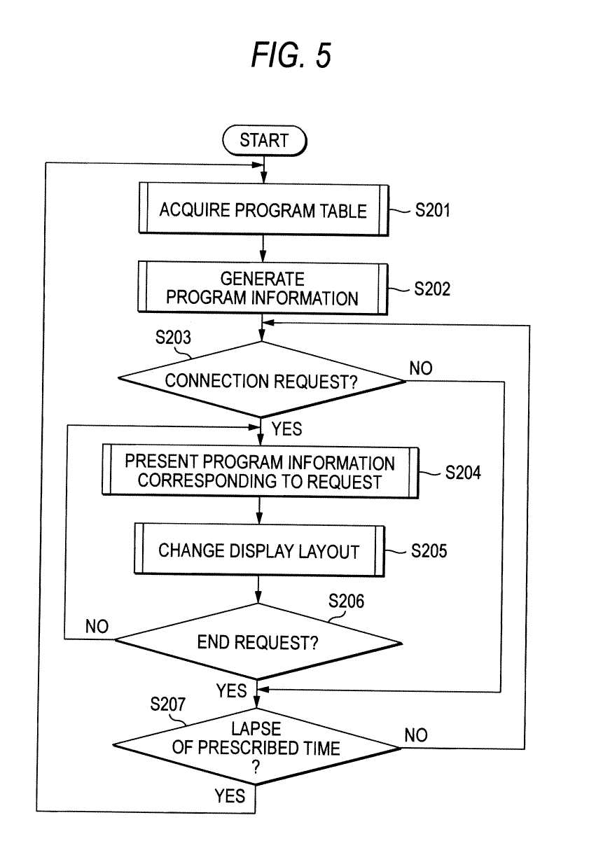

Next, a process which is executed by the apparatus 101 will be described with reference to a flowchart of FIG. 5.

At step S201, the apparatus 101 extracts program structures and related keywords such as persons who appear, outlines, inserted tunes, etc. of respective programs from receivers such as the apparatus 103 or servers which provide program information, determines their links and ranks, and forms lists of the respective programs.

At step S202, the apparatus 101 generates each document to be supplied to the apparatus 103 as program information by properly arranging references from the thus-generated lists of the respective programs and data such as CMs (commercial messages) to be previously scheduled. Each document contains a special script as shown in FIGS. 4A and 4B. The presentation contents are varied with time by dividing each program into sections of 10 minutes, for example, and changing the references from the list and the data of items to be displayed such as CMs.

If receiving a connection request from the apparatus 103, at step S203 the apparatus 101 returns a document to configure a portal containing links to the documents that were generated at step S202.

If a transition is made to a document that was generated at step S202, viewing program identifying information are communicated from the apparatus 103 to the apparatus 101 in small steps or at the same time through processing of the script shown in FIGS. 4A and 4B. At step S204, the apparatus 101 sends a document which was generated at step S202 and is identified by a reception area, a channel, a start time of a program being displayed, and its playback position to the apparatus 103 as a reply to the above communication.

At step S205, the apparatus 101 stores the links etc. in the accessed document together with a playback position, at a time of the access, of the program being displayed and updates the ranks. Such updating is performed in the same manner for access from a third apparatus, and links that attract more attention are given higher ranks automatically. Such ranking is reflected in a document that will be acquired thereafter being designated at the same playback position.

At step S206, the connection to the apparatus 103 is canceled with, for example, timing that the apparatus 103 finishes the operation of the browser script processing section 202.

At step S207, the apparatus 101 generates new documents every prescribed time, for example, every time the program table is updated. The apparatus 101 waits for a request from the apparatus 103 until the prescribed time elapses.

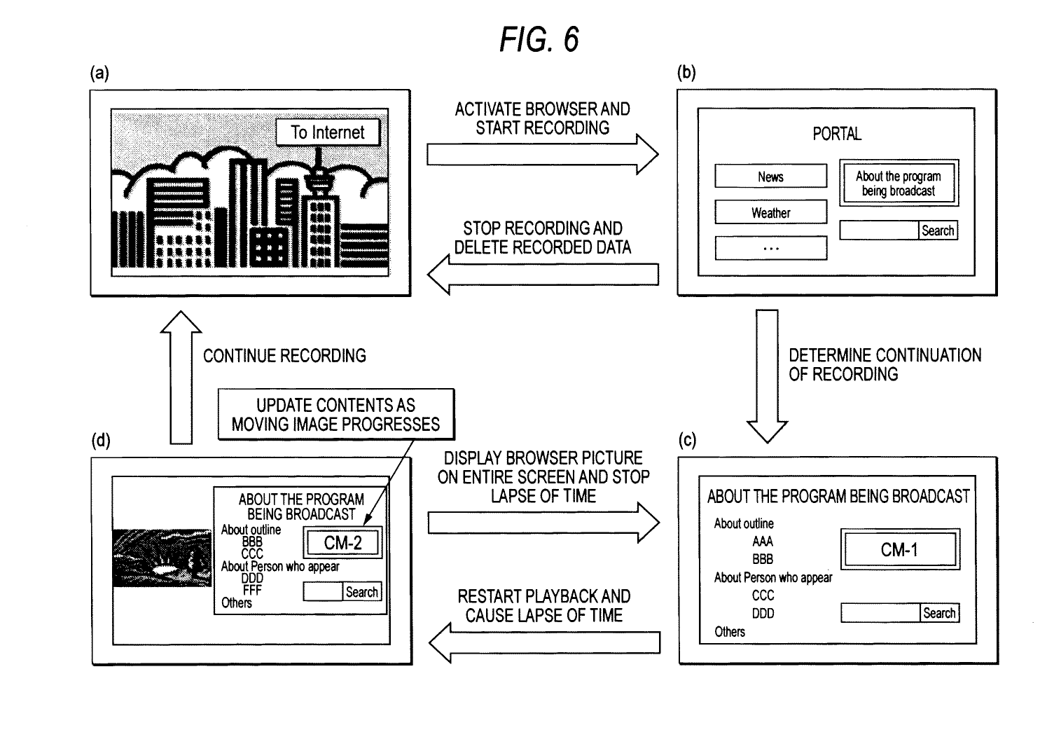

FIG. 6 illustrates an example operation of the embodiment.

If the user of the apparatus 103 selects the button “To Internet” which is located at a top-right position in the picture of part (a) of FIG. 6, the browser is activated, recording is started, and a transition is made to a portal picture shown in part (b) of FIG. 6. If stop of recording/deletion of recorded data is selected at this stage, a return is made to the state of part (a). On the other hand, if the button “About the program being broadcast” is selected, continuation of the recording is determined and a transition is made to a picture relating to the program being broadcast (see part (c) of FIG. 6). If the playback is restarted and passage of time is caused at this stage, as shown in part (d) of FIG. 6 the program being recorded is displayed together with updated contents such as an outline, persons who appear, and a CM of the program being recorded.

According to the embodiment as described above,

(1) browsing can be performed without the need for paying attention to the progress of a program, whereby the user's convenience is enhanced;

(2) a server can be constructed which can automatically provide information that is more suitably corresponding to the progress of a program; and

(3) advertisements can be presented efficiently by time-division in a limited and advertisement-dedicated display area (e.g., a CM can be displayed in a browser picture immediately after its broadcast).

Since a program is identified by using a script, the embodiment provides an advantage that the convenience of a user is enhanced by allowing the user to perform browsing without the need for paying attention to a Web page that is opened first or the progress of the program.

The invention is not limited to the above embodiment and may be modified without departing from the spirit and scope of the invention.

And various inventions can be conceived by properly combining plural constituent elements disclosed in the embodiment. For example, several ones of the constituent elements of the embodiment may be omitted.

According to an aspect of the present invention, there is provided a technique for allowing a user to more freely browse information that relates to a broadcast.

What is claimed is:

1. A receiver configured to perform browsing of information relating to a broadcast program to be received and/or recorded by accessing to an Internet server being independent of the broadcast program, the receiver comprising:
a browsing module configured to perform the browsing;
a recording module configured to start, upon a start of the browsing, recording of the broadcast program being broadcasted and viewed; and
a replying module configured to return, upon receiving of an acquisition request from the Internet server, identifying information relating to the broadcast program that has been viewed so far or being viewed to the server.

2. The receiver of claim 1,
wherein the replying module returns the identifying information via a script in a content of the broadcast program.

3. The receiver of claim 1,
wherein, if the browsing is finished after a reception of the acquisition request, the receiver starts a playback of the broadcast program from a head of a recorded part of the broadcast program.

4. The receiver of claim 1,
wherein, if the browsing is finished without receiving the acquisition request, the receiver stops a time-shift playback and deletes a recorded part of the broadcast program.

5. The receiver of claim 1,
wherein, after reception of the acquisition request, the replying module returns the identifying information only for a document obtained by a secret communication.

6. The receiver of claim 1, further comprising:
a display unit configured to display a content of the broadcast program.

7. A receiving method for a receiver configured to perform browsing of information relating to a broadcast program to be received and/or recorded by accessing to an Internet server being independent of the broadcast program, the method comprising:
performing the browsing;
starting, upon a start of the browsing, recording of the broadcast program being broadcasted and viewed; and
returning, upon receiving of an acquisition request from the Internet server, identifying information relating to the broadcast program that has been viewed so far or being viewed to the server.

8. A data communication system comprising:
the receiver of claim 1; and
a server configured to send the receiver the acquisition request, and to provide browsing information corresponding to the identifying information upon reception of a reply to the acquisition request.
